(19) United States
(12) Patent Application Publication
(10) Pub. No.: US 2009/0090059 A1
(43) Pub. Date: Apr. 9, 2009

(54) System and method of using rope in security application

(76) Inventor: Justin Bishop, West Caldwell, NJ (US)

Correspondence Address: MCDERMOTT WILL & EMERY LLP, 600 13TH STREET, N.W., WASHINGTON, DC, 20005-3096, US

(21) Appl. No.: 11/879,271

(22) Filed: Jul. 16, 2007

Related U.S. Application Data
(60) Provisional application No. 60/831,101, filed on Jul. 14, 2006.

(51) Int. Cl. F16G 11/00; E01F 15/06; E01F 13/00; E01F 13/12

(52) U.S. Cl. 49/9; 24/115 R; 404/6

(57) ABSTRACT

Embodiments of this invention include describe an improved apparatus and method for using ropes with security units/barriers deployed in water or on land. The ropes are preferrably deployed with hollow plastic tubes which protect the ropes from abrasion, UV light, and damage from animals. A rope contained within a tube is under no stress until an intruding object impacts the security barrier and the security barrier reaches its elastic limit.

### CROSS REFERENCES TO RELATED APPLICATIONS

This application claims the benefit of U.S. Provisional Application Ser. No. 60/831,101, filed 14 Jul. 2007, the contents of which are hereby incorporated by reference herein in their entirety.

### FIELD OF THE INVENTION

Embodiments of this invention include using ropes with security units/barriers deployed on land or in water and describe an improved apparatus and method for this purpose.

### Countering Terrorism.

This invention may be utilized in countering terrorism. Unwelcome objects, such as land and sea vehicles, attempting to intrude into populated, secure, or sensitive areas are commonly employed in terrorist activities. As part of efforts to counter terrorism, there is an urgent need to prevent penetration of such objects into such populated, secure, or sensitive area. One or more embodiments of this invention will aid in this prevention.

### BACKGROUND OF THE INVENTION

This invention concerns using ropes with security units/barriers deployed on land or in water.

For such applications, ropes used must be very strong. Some new rope fibers have moduli almost as high as steel. These fiber ropes are very durable and do not corrode. Further, they are light-weight and easy to handle. Some of these fiber ropes have tension and bending fatigue performance superior to those of wire ropes and, thus, may and may be stronger than steel.

Common types of high-strength fiber ropes include, without limitation:

High Molecular Weight Polyethylene

Spectra Fiber

Polyester

Vectran

Dyneema

Fiber Ropes

expanded polytetrafluoroethylene (ePTFE)

Aramid

Kevlar

Carbon Fiber

Ceramic Fiber Ropes

Nylon

PET

Polypropylene

Unmanila

PBO (Dow) Polybenzoxazole

An in-depth overview of high-strength fiber ropes has been published by Flory, McKenna, and Parsey (see Flory, John F.; McKenna, Henry A.; and Parsey, Mike R.; “Fiber Ropes For Ocean Engineering in the 21st Century”; 1982; available at www.tensiontech.com/papers/papers/deep_mor/deep_mor.html).

A further use of these high-strength fiber ropes is in combination ropes. A combination rope is a uniquely designed rope which combine polyester and polypropylene-polyethylene fibers together. This design combines the durability and high abrasion resistance of polyester with the light weight of polypropylene-polyethylene fibers. Most manufacturers have brand names for these types of ropes.

### BRIEF SUMMARY OF THE INVENTION

In one embodiment, this invention comprises a rope for use in a security unit deployed at sea or on land.

In another embodiment, this invention comprises a method for using rope in a security unit deployed at sea or on land.

In still another embodiment, this invention comprises apparatus using rope in a security unit deployed at sea or on land.

### BRIEF DESCRIPTION OF THE SEVERAL VIEWS OF THE DRAWING

FIG. 1 is a view of one embodiment of this invention.

FIG. 2 is another view of one embodiment of this invention.

FIG. 3 is another view of one embodiment of this invention.

FIG. 4 is another view of one embodiment of this invention.

FIG. 5 is another view of one embodiment of this invention.

FIG. 6 is another view of one embodiment of this invention.

FIG. 7 is another view of one embodiment of this invention.

FIG. 8 is another view of one embodiment of this invention.

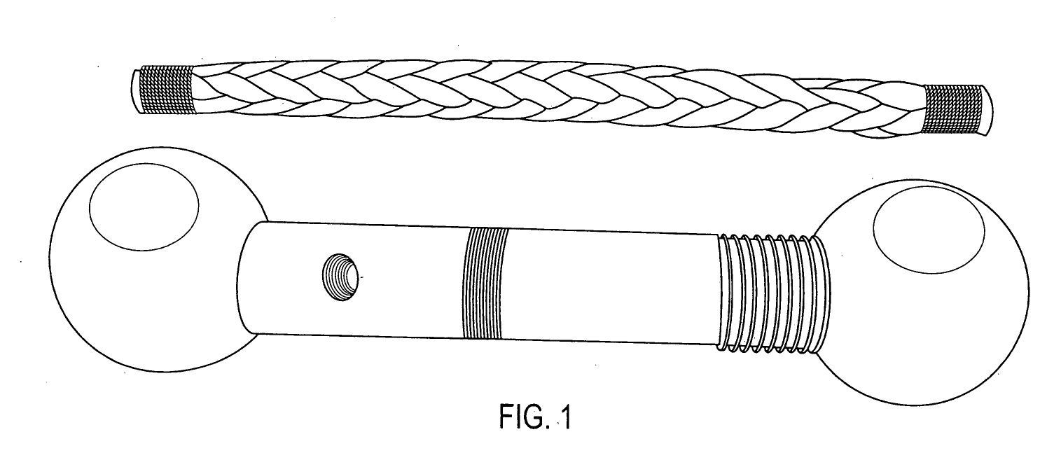

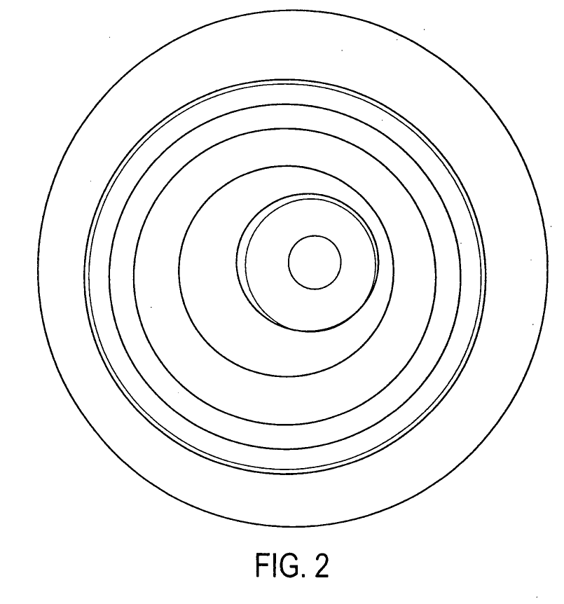

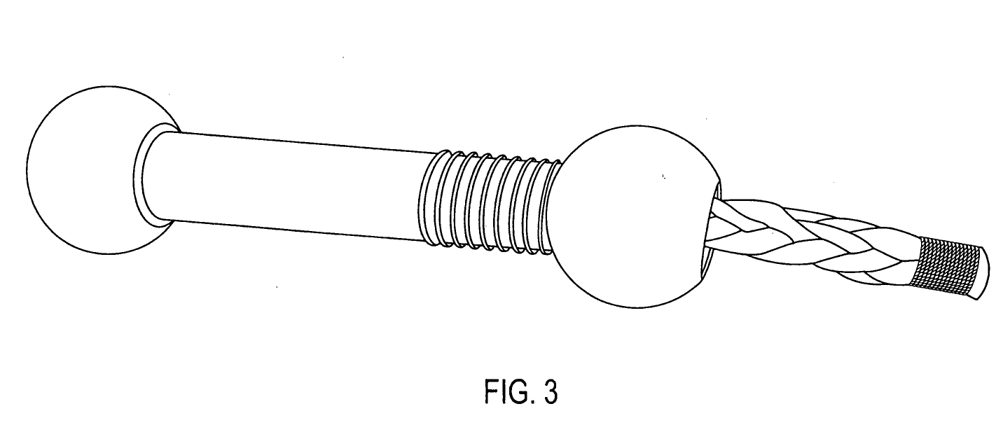

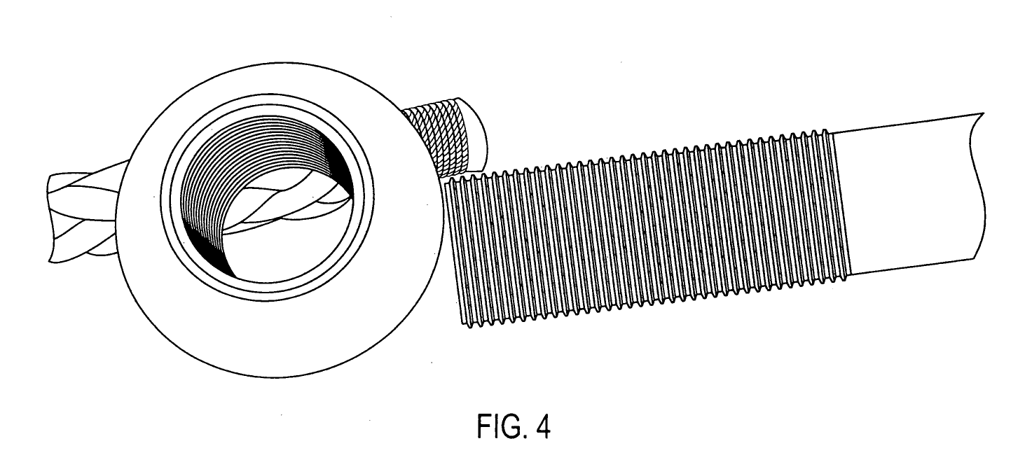

### DETAILED DESCRIPTION OF THE INVENTION

In a preferred embodiment of this invention, a fiber rope is employed in conjunction with a security barrier at sea. Another preferred embodiment is an analogous use with a security barrier on land.

The security barrier may be of conventional design adapted to accommodate the addition of ropes, as described below. Alternatively, the security barrier may be designed specifically to utilize ropes, as described below. Security barrier design is well-known in the relevant art.

The rope itself is one of the fiber types or combination ropes having high-strength properties and corrosion resistance; such ropes are well-known in the prior art.

The rope is secured to the security barrier in a way that increases the overall strength of the barrier. Preferrably, portions of the rope are deployed in hollow plastic tubes; each such composite unit being designated a “rope tube”. The plastic of the tube is preferrably HDPE.

Consequently, a rope tube is composed of a plastic shell and a rope fiber core. The tube provides structural integrity for an encompassing security unit in normal and storm sea conditions independent of the rope.

The tube shrouds the rope contained within the tube protecting it from abrasion, UV light, and damage from animals. The rope contained within the tube is under no stress until a boat impacts the security barrier.

The ropes are only attached to the rope tubes at the ends of the rope tubes, preferrably by a screw-top method. This attachment method permits the rope tube to be structurally joined to the security barrier itself.

Thus, the rope tube allows the rope to act as a structural member in the security barrier system.

In use, the rope while in the rope tube has some slack and is activated only when the elastic properties of the barrier system are reached.

When a boat or other intrusive object impacts the security barrier, the barrier panels and the plastic tubes move as one unit, commonly bending in a shape similar to a parabolic curve. When the elastic limit of the security unit panels and plastic tubes is reached, the ropes contained within the rope tubes are played out and put under tension. Once any rope is taut, that rope's ends are placed under a load, and that rope acts as an arrester cable stopping the boat's forward progress through the barrier.

Therefore, although this invention has been described with a certain degree of particularity, it is to be understood that the present disclosure has been made only by way of illustration, and that numerous changes in the details of the apparatus and method may be resorted to without departing from the spirit and scope of the invention. For example, without limitation, the security barrier may be deployed in a land-based use rather than at sea. Also, traditional high-strength rope, such as wire rope, may be utilized if the specific rope's properties match the needs of the particular application.

I claim:

1. A rope tube for use in a security barrier, the rope tube comprising:
a hollow tube; and
a rope partially contained within the hollow tube.

2. A security barrier comprising:
a rope tube comprising:
a hollow tube; and
a rope partially contained within the hollow tube.

3. A method for constructing a security barrier, the method comprising the step of:
incorporating into the security barrier a rope tube comprising a hollow tube and a rope partially contained within the hollow tube.
